(19) United States
(12) Patent Application Publication
(10) Pub. No.: US 2009/0320588 A1
(43) Pub. Date: Dec. 31, 2009

(54) SYSTEM AND METHOD FOR MEASURING OR CHARACTERIZING PROPERTIES OF ULTRA-FINE OR COHESIVE POWDERS USING VIBRATIONS

(75) Inventors: Rajesh N. Dave, Princeton, NJ (US); Miguel-Angel Sanchez-Quintanilla, Sevilla (ES); Lauren Elizabeth Beach, Florence, MA (US)

Correspondence Address: NEW JERSEY INSTITUTE OF TECHNOLOGY, 323 MARTIN LUTHER KING, JR. BOULEVARD, OFFICE OF RESEARCH AND DEVELOPMENT, NEWARK, NJ, 07102-1982, US

(73) Assignee: New Jersey Institute of Technology, Newark, NJ (US)

(21) Appl. No.: 12/419,792

(22) Filed: Apr. 7, 2009

Related U.S. Application Data
(60) Provisional application No. 61/042,978, filed on Apr. 7, 2008.

(51) Int. Cl. G01N 9/00; G01N 11/00

(52) U.S. Cl. 73/32 A; 73/861.18

(57) ABSTRACT

The present disclosure provides for systems and methods for measuring and/or characterizing properties of ultra-fine or cohesive powders. More particularly, the present disclosure provides for systems and methods for measuring and/or characterizing packing density and/or flowability of ultra-fine or cohesive powders using vibrations. In one embodiment, the present disclosure provides for systems and methods for improved characterization or specification of powder or packing density as a function of consolidation stress. In an exemplary embodiment, the present disclosure also provides for systems and methods for improved characterization or definition of a parameter which indicates the flow property of the powder.

### CROSS-REFERENCE TO RELATED APPLICATIONS

The present application claims the benefit of U.S. Provisional Patent Application Ser. No. 61/042,978 filed Apr. 7, 2008, entitled “System and Method for Measuring or Characterizing Properties of Ultra-Fine or Cohesive Powders Using Vibrations”, the entire disclosure of which is incorporated herein by reference.

### FEDERAL GOVERNMENT LICENSE RIGHTS

The work described in this patent disclosure was sponsored, at least in part, by the following Federal Grants: NSF-IGERT Grant No. DGE-0504497 and NSF-ERC Grant No. EEC-0540855. Therefore, the United States government may hold license and/or other rights in this invention as a result of the aforementioned financial support.

### FIELD OF THE INVENTION

The present disclosure relates to systems and methods for measuring and/or characterizing properties of ultra-fine or cohesive powders, and, more particularly, to systems and methods for measuring and/or characterizing packing density and/or flowability of ultra-fine or cohesive powders using vibrations.

### BACKGROUND OF THE INVENTION

In general, there is a need for utilizing ultra-fine powders (e.g., powders less than about 25 microns in size) in many industries. Ultra-fine powders are useful in a myriad of different environments for commercial and industrial applications, such as, for example, pharmaceutical applications, agrochemical applications, food applications, and energetic materials applications.

However, ultra-fine powders are typically very cohesive and pose a number of practical problems (e.g., handling, flow, mixing, fluidization and subsequent processing). In addition, ultra-fine powders pose problems in regards to accurately measuring and/or characterizing certain properties of the ultra-fine or cohesive powders, such as, for example, powder cohesion, packing density, flowability and/or fluidization behavior. In general, accurate knowledge of certain powder properties (e.g., packing density, flowability, etc.) also may help in powder filling processes, which may ultimately impact product uniformity (e.g., for pharmaceutical products and/or for other industrial products).

One currently utilized methodology to attempt to measure properties of some powders is to utilize Carr indices. One commercial device used to attempt to measure properties of some powders utilizing Carr indices is a device marketed by Hosokawa Micron (e.g., the Hosokawa Powder Tester). In general, devices such as the Hosokawa Powder Tester, for example, are costly, and they fail to accurately measure and/or characterize properties of ultra-fine or nearly cohesive powders. That is because, for example, Carr's indices were proposed several decades ago when powders finer than 30 microns were less prevalent and powders finer than about 50 microns were categorized in a single class. In general, there is an increasing need to further classify the behavior of fine powders, and a need to have the ability to accurately distinguish the changes in flow behavior in fine, cohesive powders due to additives (e.g., flow additives) intended for flow improvement/enhancement. One method, as described for example in U.S. patent application Ser. No. 11/512,453 (U.S. Patent Publication No. 2007/0053846), for flow enhancement is dry powder coating, accomplished, for example, by use of a magnetically assisted impaction coating (MAIC) device. The foregoing reference is incorporated herein in its entirety. Typically, when a cohesive powder is dry coated with small amounts of additive powder (e.g., nano-silica additive powder), the flow improves, but due to the small size of the powder, the powder also become easily fluidizable and it is therefore difficult to use the Hosokawa Powder Tester device or the like, for example, to measure tapped density, because the powder would spill out of the sample holder when conducting the tests.

In addition to devices such as the Hosokawa Powder Tester, there are other devices that conform to United States Pharmacopeia-National Formulary (“USP/NF)” standards that are used to attempt to measure properties of some powders. In general, these devices are typically Packing Density Method/Apparatus devices. However, these devices also fail to provide accurate or reliable measurement and/or characterization results for ultra-fine or cohesive powders. Typically, many of these devices do not provide meaningful measurement and/or characterization results that relate well to the flowability or the fluidization nature of the ultra-fine or cohesive powders. Moreover, these devices typically provide a single, numerical value for the packed density, which does not capture the full dynamical behavior of the cohesive or ultra-fine powders.

Thus, despite efforts to date, a need remains for cost effective systems/methods that provide accurate measurement and/or characterization results (e.g., packing density, flowability, and/or fluidization behavior) for ultra-fine or cohesive powders. These and other inefficiencies and opportunities for improvement are addressed and/or overcome by the systems and methods of the present disclosure.

### SUMMARY OF THE INVENTION

The present disclosure provides for advantageous systems and methods for measuring and/or characterizing properties of ultra-fine or cohesive powders. In exemplary embodiments, the present disclosure provides for improved systems and methods for measuring and/or characterizing packing density and/or flowability of ultra-fine or cohesive powders using vibrations.

The present disclosure provides for a powder measuring device system including a shaker that includes a plate, the plate configured and dimensioned to releasably secure a cell containing a given mass of ultra-fine powder; a container of material having a flow line in communication with a flow controller, the flow controller having an output line in communication with the cell; a controller in communication with the shaker, the controller configured to operate and maintain the shaker at a vibration amplitude or tapping setting; wherein the flow controller is configured to control a flow rate of the material from the container to the cell; wherein the material is supplied to the cell at a flow rate to fluidize the powder in the cell until the powder is fully expanded; wherein the height of the powder in the cell is measured and monitored while the material is supplied to the cell; wherein the supply of material is shut off after the powder is fully expanded and the powder is allowed to collapse undisturbed; wherein the height of the collapsed undisturbed powder in the cell is measured; and wherein after the height of the collapsed undisturbed powder is measured, vibrations or taps are applied to the cell by the shaker, and the height of the powder in the cell is measured and recorded as a function of time.

The present disclosure also provides for a powder measuring device system further comprising a sensor in communication with the cell, the sensor configured to measure, record and monitor the height of the powder in the cell, and wherein the height of the powder in the cell is measured, recorded and monitored by the sensor.

The present disclosure also provides for a powder measuring device system wherein the shaker is an electrodynamic shaker. The present disclosure also provides for a powder measuring device system wherein the shaker is configured and dimensioned to subject the cell to vertical taps. The present disclosure also provides for a powder measuring device system wherein the cell is a cylindrical fluidization cell. The present disclosure also provides for a powder measuring device system wherein the cell has an internal diameter of about 5.08 cm and a height of about 19.2 cm. The present disclosure also provides for a powder measuring device system wherein the plate is a distributor plate. The present disclosure also provides for a powder measuring device system wherein the distributor plate is sintered porous stainless steel having a pore size of about five micro-meters and a thickness of about 3.2 mm. The present disclosure also provides for a powder measuring device system wherein the ultra-fine powder is less than about 25 microns in particle size. The present disclosure also provides for a powder measuring device system wherein the container is a gas container that contains a supply of gas. The present disclosure also provides for a powder measuring device system wherein the container is a dry nitrogen container that contains a supply of dry nitrogen (dry N₂). The present disclosure also provides for a powder measuring device system wherein the flow controller is a rotameter.

The present disclosure also provides for a powder measuring device system wherein the sensor is an ultrasound sensor. The present disclosure also provides for a powder measuring device system wherein the sensor is positioned on top of the cell. The present disclosure also provides for a powder measuring device system wherein the sensor is connected to a processor. The present disclosure also provides for a powder measuring device system further comprising an accelerometer in communication with the cell, the accelerometer configured to measure the vertical acceleration of the cell; and a power amplifier in communication with the accelerometer and the shaker, wherein the controller and the power amplifier are configured to operate and maintain the shaker at a vibration amplitude or tapping setting.

The present disclosure also provides for a powder measuring device system wherein the accelerometer is a piezoelectric accelerometer. The present disclosure also provides for a powder measuring device system wherein the accelerometer is positioned on the upper part of the cell. The present disclosure also provides for a powder measuring device system wherein the controller is a vibration or tapping controller. The present disclosure also provides for a powder measuring device system wherein the vibration amplitude or tapping setting is maintained by operating the shaker in a closed loop configuration using the controller and the power amplifier. The present disclosure also provides for a powder measuring device system wherein the material supplied to the cell from the container is gas. The present disclosure also provides for a powder measuring device system wherein the material supplied to the cell from the container is dry nitrogen (dry N₂).

The present disclosure also provides for a powder measuring device system wherein the flow rate of material supplied to the cell is increased while the height of the powder in the cell is measured and monitored. The present disclosure also provides for a powder measuring device system wherein the flow rate of material is maintained at a constant or variable rate for about 30 seconds after the powder is fully expanded. The present disclosure also provides for a powder measuring device system wherein the powder in the cell is shaken or tapped at least once by the shaker when the material is supplied to the cell. The present disclosure also provides for a powder measuring device system wherein the frequency of the vibrations applied to the cell is fixed at about 60 Hz. The present disclosure also provides for a powder measuring device system wherein the frequency of the vibrations applied to the cell is from about 1 Hz to about 1000 Hz. The present disclosure also provides for a powder measuring device system wherein the height of the powder in the cell is measured and recorded by the sensor while or after the vibrations or taps are applied to the cell, and wherein the height of the powder in the cell is measured and recorded by the sensor at a rate of about 20 Hz. The present disclosure also provides for a powder measuring device system wherein the vibration amplitude setting is from about 0 to about 2.5 mm. The present disclosure also provides for a powder measuring device system wherein the vibration amplitude is from about 0 g to about 10 g. The present disclosure also provides for a powder measuring device system wherein the vibration amplitude is from about 0 g to about 5 g. The present disclosure also provides for a powder measuring device system wherein the tapping setting is set at a frequency of a tap in a range from about every five seconds to a tap about every one second. The present disclosure also provides for a powder measuring device system wherein there is a finite time of relaxation between each consecutive tap.

The present disclosure also provides for a method for measuring a powder, the method including providing a shaker that includes a plate, the plate configured and dimensioned to releasably secure a cell containing a given mass of ultra-fine powder; providing a container of material having a flow line in communication with a flow controller, the flow controller having an output line in communication with the cell, and wherein the flow controller is configured to control a flow rate of the material from the container to the cell; providing a controller in communication with the shaker, the controller configured to operate and maintain the shaker at a vibration amplitude or tapping setting; supplying the material to the cell at a flow rate to fluidize the powder in the cell until the powder is fully expanded; measuring and monitoring the height of the powder in the cell while the material is supplied to the cell; shutting off the supply of measuring the height of the collapsed undisturbed powder in the cell; applying vibrations or taps material after the powder is fully expanded; allowing the powder to collapse undisturbed; to the cell with the shaker after the height of the collapsed undisturbed powder is measured; and measuring and recording the height of the powder in the cell as a function of time while or after the vibrations or taps are applied to the cell.

The present disclosure also provides for a method for measuring a powder further comprising providing a sensor in communication with the cell, the sensor configured to measure, record and monitor the height of the powder in the cell; and measuring, recording and monitoring the height of the powder in the cell with the sensor. The present disclosure also provides for a method for measuring a powder wherein the shaker is an electrodynamic shaker. The present disclosure also provides for a method for measuring a powder wherein the shaker is configured and dimensioned to subject the cell to vertical taps. The present disclosure also provides for a method for measuring a powder wherein the cell is a cylindrical fluidization cell. The present disclosure also provides for a method for measuring a powder wherein the cell has an internal diameter of about 5.08 cm and a height of about 19.2 cm.

The present disclosure also provides for a method for measuring a powder wherein the plate is a distributor plate. The present disclosure also provides for a method for measuring a powder wherein the distributor plate is sintered porous stainless steel having a pore size of about five micro-meters and a thickness of about 3.2 mm. The present disclosure also provides for a method for measuring a powder wherein the ultra-fine powder is less than about 25 microns in particle size. The present disclosure also provides for a method for measuring a powder wherein the container is a gas container that contains a supply of gas. The present disclosure also provides for a method for measuring a powder wherein the container is a dry nitrogen container that contains a supply of dry nitrogen (dry N₂). The present disclosure also provides for a method for measuring a powder wherein the flow controller is a rotameter. The present disclosure also provides for a method for measuring a powder wherein the sensor is an ultrasound sensor. The present disclosure also provides for a method for measuring a powder wherein the sensor is positioned on top of the cell. The present disclosure also provides for a method for measuring a powder wherein the sensor is connected to a processor.

The present disclosure also provides for a method for measuring a powder further comprising providing an accelerometer in communication with the cell, the accelerometer configured to measure the vertical acceleration of the cell; and providing a power amplifier in communication with the accelerometer and the shaker, wherein the controller and the power amplifier are configured to operate and maintain the shaker at a vibration amplitude or tapping setting.

The present disclosure also provides for a method for measuring a powder wherein the accelerometer is a piezoelectric accelerometer. The present disclosure also provides for a method for measuring a powder wherein the accelerometer is positioned on the upper part of the cell. The present disclosure also provides for a method for measuring a powder wherein the controller is a vibration or tapping controller. The present disclosure also provides for a method for measuring a powder wherein the vibration amplitude or tapping setting is maintained by operating the shaker in a closed loop configuration using the controller and the power amplifier. The present disclosure also provides for a method for measuring a powder wherein the material supplied to the cell from the container is gas. The present disclosure also provides for a method for measuring a powder wherein the material supplied to the cell from the container is dry nitrogen (dry N₂). The present disclosure also provides for a method for measuring a powder wherein the flow rate of material supplied to the cell is increased while the height of the powder in the cell is measured and monitored. The present disclosure also provides for a method for measuring a powder wherein the flow rate of material is maintained at a constant or variable rate for about 30 seconds after the powder is fully expanded. The present disclosure also provides for a method for measuring a powder wherein the powder in the cell is shaken or tapped at least once by the shaker when the material is supplied to the cell.

The present disclosure also provides for a method for measuring a powder wherein the frequency of the vibrations applied to the cell is fixed at about 60 Hz. The present disclosure also provides for a method for measuring a powder wherein the frequency of the vibrations applied to the cell is from about 1 Hz to about 1000 Hz. The present disclosure also provides for a method for measuring a powder wherein the height of the powder in the cell is measured and recorded with the sensor while or after the vibrations or taps are applied to the cell, and wherein the height of the powder in the cell is measured and recorded with the sensor at a rate of about 20 Hz. The present disclosure also provides for a method for measuring a powder wherein the vibration amplitude setting is from about 0 to about 2.5 mm.

The present disclosure also provides for a method for measuring a powder wherein the vibration amplitude is from about 0 g to about 10 g. The present disclosure also provides for a method for measuring a powder wherein the vibration amplitude is from about 0 g to about 5 g. The present disclosure also provides for a method for measuring a powder wherein the tapping setting is set at a frequency of a tap in a range from about every five seconds to a tap about every one second. The present disclosure also provides for a method for measuring a powder wherein there is a finite time of relaxation between each consecutive tap.

Additional advantageous features, functions and applications of the disclosed systems and methods of the present disclosure will be apparent from the description which follows, particularly when read in conjunction with the appended figures.

### BRIEF DESCRIPTION OF THE FIGURES

To assist those of ordinary skill in the art in making and using the disclosed systems and methods, reference is made to the appended figures, wherein:

FIG. 1 is a frontal view of an embodiment of a powder measuring device system according to the present disclosure;

FIG. 2 depicts results of continuously sampled values of packing density of Acetaminophen (APAP) coated with silica shown as a function of time at a given applied acceleration, where the plateau reached is taken as the final value of the packing density at that particular applied acceleration condition;

FIG. 3 depicts results of a packing density study using cornstarch coated with various levels of silica shown as a function of applied acceleration;

FIG. 4 depicts results of a packing density study using cornstarch coated with various levels of silica shown as a function of apparent weight of the powder bed; and

FIG. 5 depicts results of a packing density study using various materials (both materials 25 coated with various levels of additives, and uncoated materials) shown as a function of applied acceleration.

### DETAILED DESCRIPTION OF THE INVENTION

The present disclosure provides for systems and methods for measuring and/or characterizing properties of ultra-fine or cohesive powders. More particularly, the present disclosure provides for improved systems and methods for measuring and/or characterizing packing density and/or flowability of ultra-fine or cohesive powders using vibrations.

Current practice provides that some devices/methods used to attempt to measure properties of some powders utilizing Carr indices fail to accurately measure properties of ultra-fine or nearly cohesive powders. In general, these devices/methods only provide an indication of qualitative evaluation of flow behavior, and they do not provide sufficient detail to differentiate flow behavior between various poorly flowing cohesive powders, for example. Furthermore these devices/methods cannot accurately distinguish influence of flow additives on improvement in flow behavior. In addition, such devices/methods are typically costly. Current practice also provides that other devices/methods (e.g., Packing Density Method/Apparatus devices) used to attempt to measure properties of some powders utilizing USP/NF standards also fail to accurately or reliably measure properties of ultra-fine or cohesive powders, in a manner similar to the devices/methods utilizing Carr indices. In addition, such devices/methods typically do not provide any measurement and/or characterization results that relate adequately to the flowability and/or fluidization nature of the ultra-fine or cohesive powders, nor do they allow accurate characterization of flow improvement due to additives to poorly flowing powders.

In exemplary embodiments, the present disclosure provides for improved and cost effective systems/methods that provide accurate measurement and/or characterization results (e.g., packing density, flowability, and/or fluidization behavior) for ultra-fine or cohesive powders. In exemplary embodiments, the present disclosure also provides for improved systems/methods for measuring and/or characterizing properties of ultra-fine or cohesive powders, wherein the accurate knowledge of certain properties of the powders (e.g., packing density, flowability) may be beneficial in industrial applications (e.g., powder filling processes, product uniformity, pharmaceutical applications, etc.), thereby providing a significant manufacturing and commercial advantage as a result. In exemplary embodiments, the present disclosure also provides for systems and methods for measuring and/or characterizing properties of ultra-fine or cohesive powders, wherein differences in the flowability and/or fluidization behavior between different ultra-fine or cohesive powders may be detected, and wherein the accurate knowledge of the differences in the flowability and/or fluidization behavior between different ultra-fine or cohesive powders may be detected, and wherein the accurate knowledge of the differences in the flowability and/or fluidization behavior between the powders may be beneficial in industrial applications, thereby providing a significant manufacturing and commercial advantage as a result.

In general, the present disclosure also provides for systems and methods for improved characterization or specification of powder or packing density as a function of consolidation stress. In one embodiment, a series of curves for the packing density is obtained, rather than obtaining a single value as compared to conventional methods. This is particularly useful in gaining better understanding of the powder flow behavior under various processing conditions because powder properties are measured for a series of consolidation stress values in exemplary embodiments of the present disclosure, representing a whole range of process conditions, rather than just one state as done in typical existing methods. In an exemplary embodiment, the present disclosure also provides for systems and methods for improved characterization or definition of a parameter which indicates the flow property of the powder. For example, the parameter of the powder may be the Hausner ratio or the like, which indicates the flow property (e.g., flowability) of the powder.

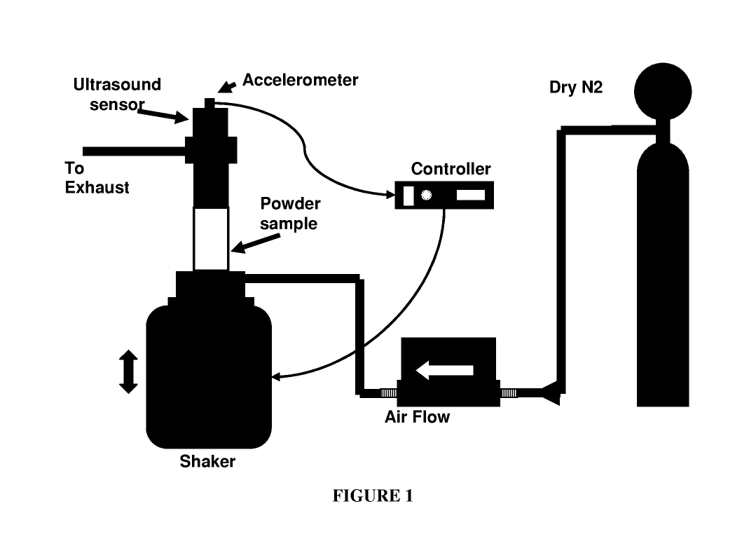

Referring now to the drawings, and in particular to FIG. 1, there is illustrated a powder measuring device system 10 depicting an embodiment of the present disclosure. For example, powder measuring device system 10 may be a powder density or packing density measuring device system and/or a powder flowability or fluidization measuring device system. In an exemplary embodiment, powder measuring device system 10 is a powder density or packing density measuring device system and/or a powder flowability or fluidization measuring device system that provides improved characterization or specification of powder density as a function of consolidation stress. In one embodiment, a series of curves for the packing density is obtained from the powder measuring device system 10, rather than obtaining a single value as compared to conventional methods. Powder measuring device system 10 may also provide for improved characterization or definition of a parameter which indicates the flow property of the powder. For example, the parameter may be the Hausner ratio or the like, which indicates the flow property of the powder.

In an exemplary embodiment, powder measuring device system 10 is used to measure and/or characterize the packing density of a ultra-fine or cohesive powder by utilizing a shaker 12. In general, ultra-fine powders are less than about 25 microns in size. Typically, ultra-fine powders are cohesive or nearly cohesive. Exemplary shaker 12 takes the form of an electrodynamic shaker, although the present disclosure is not limited thereto. Rather, shaker 12 may take a variety of forms. In one embodiment, shaker 12 is a Labworks Inc., Model ET-127 Electrodynamic Shaker. In an alternative embodiment, shaker 12 is configured and dimensioned to subject the cell 16 to vertical taps or the like instead of continuous vibrations. For example, the frequency of tapping the cell 16 may be set in the range from a tap about every five seconds to a tap about every one second. In one embodiment, there is a finite time of relaxation between two consecutive taps (e.g., “dead” time between each consecutive tap).

Typically, powder measuring device system 10 includes a shaker 12 having a plate 14 configured and dimensioned to releasably secure a cell 16 of system 10. Exemplary plate 14 takes the form of a distributor plate 14, although the present disclosure is not limited thereto. Rather, plate 14 may take a variety of forms. In one embodiment, plate 14 is a distributor plate 14, wherein the distributor plate 14 is fabricated out of perforated and/or porous material. Typically, the perforated and/or porous material of distributor plate 14 allows gas flow to fluidize or consolidate a powder in the cell 16. In an exemplary embodiment, distributor plate 14 is a sintered metal plate having pore sizes of about five microns, although the present disclosure is not limited thereto.

In general, the powder to be measured or characterized is placed in cell 16. Exemplary cell 16 takes the form of a cylindrical fluidization cell, although the present disclosure is not limited thereto. Rather, cell 16 may take a variety of forms. In one embodiment, cell 16 has an internal diameter of about 5.08 cm, and a height of about 19.2 cm. Shaker 12 may further include a distributor plate 14. In an exemplary embodiment, the distributor plate 14 of the shaker 12 is sintered porous stainless steel (e.g., Mott Corp.), having a pore size of about five micrometers and a thickness of about 3.2 mm.

As depicted in FIG. 1, generally system 10 further includes a container 18 having a flow line 20 in communication with a flow controller 22. Exemplary container 18 takes the form of a gas cylinder, although the present disclosure is not limited thereto. Rather, container 18 may take a variety of forms. In one embodiment, container 18 is dry nitrogen (dry N₂) container that is configured and dimensioned to house dry nitrogen. In one embodiment of the present disclosure, flow controller 22 is a rotameter, although the present disclosure is not limited thereto. Typically, flow controller 22 further includes an output line 24 in communication with the cell 16. In general, the flow controller 22 controls the flow or supply rate of material (e.g., gas) from the container 18 to the cell 16, through the output line 24.

In an exemplary embodiment and as depicted in FIG. 1, system 10 further includes a sensor 26 in communication with the cell 16. Exemplary sensor 26 takes the form of an ultrasound sensor, although the present disclosure is not limited thereto. Rather, sensor 26 may take a variety of forms. In one embodiment, sensor 26 is a Senix Ultra-U ultrasound sensor. In an alternative embodiment, sensor 26 is a WinSpan Ultra Sonic sensor. Sensor 26 may also be a high-accuracy, in-line sensor. Typically, sensor 26 is positioned on top of the cell 16. However, sensor 26 may be positioned in alternative positions relative to cell 16. In an exemplary embodiment, sensor 26 is connected to a processor or the like (not shown). Generally, sensor 26 measures, monitors and/or records the height of the powder contained in cell 16. In an exemplary embodiment, the accurate, in-line sensor 26 facilitates rapid, automated measurements at various consolidation stresses. In an alternative embodiment of the present disclosure, the height of the powder contained in cell 16 may be measured, monitored and/or recorded manually.

In an exemplary embodiment and as depicted in FIG. 1, system 10 further includes an accelerometer 28 in communication with the cell 16. Exemplary accelerometer 28 takes the form of a piezoelectric accelerometer, although the present disclosure is not limited thereto. Rather, accelerometer 28 may take a variety of forms. In an exemplary embodiment, accelerometer 28 is a Kistler model 8636B50M05 piezoelectric accelerometer (e.g., useful range 0 to 50 g). Typically, accelerometer 28 is positioned on the upper part of cell 16, however, accelerometer 28 may be positioned in alternative positions relative to cell 16. In an exemplary embodiment, accelerometer 28 measures the vertical acceleration of cell 16. In one embodiment and as depicted in FIG. 1, the acceleration or vibration amplitude of the shaker 12 is maintained by operating the shaker 12 in a closed loop configuration using a controller 30 and a power amplifier (not shown). Typically, the controller 30 and the power amplifier (not shown) are in communication with the accelerometer 28 and the shaker 12. Exemplary controller 30 takes the form of a vibration or tapping controller, although the present disclosure is not limited thereto. Rather, controller 30 may take a variety of forms. In an exemplary embodiment, controller 30 is a Labworks Inc. Vibelab Model VL-144 vibration controller. In addition, exemplary power amplifier (not shown) is a Labworks Inc. model PA-141 power amplifier or the like. It is to be noted that by operating the shaker 12 in a closed loop configuration using a controller 30 and a power amplifier (not shown) to vary both the frequency and amplitude of the shaking (e.g., the acceleration or vibration amplitude of the shaker 12), improved measurement accuracy and control are obtained. In an alternative embodiment of the present disclosure, the shaker 12 is not operated in a closed loop configuration to vary both the frequency and amplitude of the shaking.

The present disclosure provides for systems and methods for measuring and/or characterizing properties of ultra-fine or cohesive powders. In an exemplary embodiment and in reference to FIG. 1, the packing density and/or flowability of an ultra-fine or cohesive powder may be measured by using shaker 12 of system 10. Typically, a given mass of the powder to be measured or characterized is placed in the cell 16. In certain exemplary embodiments, powder starting materials were: cornstarch (diameter of about 15 μm, density=1.55 g/cm³) and silica R972 (diameter of about 16 nm, density=2.55 g/cm³, hydrophobic). The powders were processed in a Magnetic Assisted Impaction Coater (MAIC). Some of the materials and/or powders tested were two active pharmaceutical ingredients (“APIs”): (i) Acetaminophen (“APAP”); and (ii) Tolmetin Sodium (“Tolmetin”). A pharmaceutical excipient, Celphere was tested as well. For example, the APIs were coated with nano-silica in an MAIC for the purpose of flow improvement, while the excipient (Celphere) was coated with Magnesium Stearate to prepare an improved excipient/additive for tabletting applications.

Typically, cell 16 is then placed in the plate 14 of the shaker 12. In one embodiment, the distributor plate 14 is fabricated out of sintered porous stainless steel (Mott Corp.), with the distributor plate 14 having a pore size of about five micro-meters and a thickness of about 3.2 mm. In an exemplary embodiment, a flow of dry nitrogen (dry N₂) or the like from the container 18 is then supplied to the cell 16 through the distributor plate 14, with the flow rate of the dry nitrogen being controlled by flow controller 22. In one embodiment, a sensor 26 is positioned on top of the cell 16. The sensor 26 is typically connected to a processor or the like (not shown), and the sensor 26 measures, monitors and/or records the height of the powder in the cell 16. The vertical acceleration of the cell 16 is typically measured using an accelerometer 28. The accelerometer 28 is typically positioned on the upper part of the cell, as illustrated in FIG. 1. In an exemplary embodiment, the acceleration or vibration amplitude of the shaker 12 is maintained by operating the shaker 12 in a closed loop configuration using a controller 30 and a power amplifier (not shown). In an exemplary embodiment, the acceleration or vibration amplitude of the shaker 12 is maintained from about 0 g to about 10 g, where g is the gravitational acceleration. In one embodiment, the acceleration or vibration amplitude of the shaker 12 is maintained from about 0 g to about 5 g.

In one embodiment, to measure the packing density and/or the flowability of an ultra-fine or cohesive powder utilizing system 10, typically a given mass of the powder is placed in the cell 16. To initialize the powder, the powder is typically fluidized using material (e.g., dry nitrogen) supplied from container 18. The gas flow (e.g., the dry nitrogen flow) to the cell 16 may be increased while the bed height of the powder in the cell 16 is measured and/or monitored by the sensor 26, or is measured and/or monitored manually. Once the bed height reaches its maximum value, marking the onset of the bubbling instability, the gas flow rate may be maintained at a constant or variable rate for about 30 seconds. Typically, during the initial stages of this powder initialization process, it may be necessary to shake or tap the powder gently if the powder initially lifts as a plug, for example. In one embodiment, this gentle shake or tap of the powder is applied using the shaker 12, and this shake or tap is intended to break any bonds that may have formed between particles if the powder became consolidated, for example, either by its own weight when placed in the cell 16, or by the vibration or taps in previous runs. Once the fluidized bed is fully expanded, the gas flow may be shut off and the powder may be allowed to collapse undisturbed until the height of the bed reaches its final, constant value (the “initial solid fraction” of the powder sample in the cell). In this way, for example, the initial solid fraction obtained for each powder sample may be reproduced after each sample has been packed by the vibrations or taps. Next, vibrations or taps are applied to the cell 16 utilizing the shaker 12, and the height of the bed is measured and/or recorded by the sensor 26 as a function of time. In an exemplary embodiment, the frequency “f” of the vibrations is fixed at about 60 Hz. Typically, the desired acceleration or vibration amplitude setting is not instantly achieved, and it takes a few seconds to establish the desired acceleration or vibration amplitude. In one embodiment, the time needed to reach the desired acceleration or vibration amplitude has been minimized by increasing the gain of the power amplifier (not shown) as much as possible. In addition, the time it typically takes to reach the desired acceleration or vibration amplitude is small compared to the duration of each run. In an exemplary embodiment of the present disclosure, while the powder in the cell 16 is shaken, vibrated or tapped in this way, the height of the powder in the cell 16 is measured and/or recorded by the sensor 26 at a rate of about 20 Hz.

In one embodiment, the consolidation stress (“σ_{c}”) is taken as the maximum apparent weight per unit area of the powder sample in the cell 16 that the powder experiences as a consequence of the vibrations. In other words, the consolidation stress (σ_{c}) is:

Consolidation Stress, σ_{c}=W_{N}*[1+(4π²f²A)/(g)]

In the above formula for consolidation stress (σ_{c}), W is the weight per unit area of the powder in the final step N, g is the gravity acceleration, f is the frequency of the vibrations and A is the amplitude of the vibrations. In an exemplary embodiment, while the frequency f of the vibrations may be fixed at about 3600 vibrations per minute (f=60 Hz), the amplitude A may be adjusted between about 0 and about 2.5 mm. It is to be noted that either the frequency and/or the amplitude (or both the frequency and amplitude) may be varied and/or adjusted within a working and/or acceptable range. In one embodiment, the frequency of the vibrations applied to the cell is from about 1 Hz to about 1000 Hz. In an alternative embodiment, the cell 16 is subjected to vertical taps or the like instead of continuous vibrations. For example, the frequency of tapping may range from a tap or the like about every 5 seconds to a tap or the like about everyone second. In one embodiment, there is a finite time of relaxation between two consecutive taps.

While the amplitude of the vibrations was not measured, it was assumed to be a linear relationship between the scale (in arbitrary units) of the amplitude control of the shaker 12 and the amplitude in mm, with the higher end of the amplitude control corresponding to an amplitude of about 2.5 mm. Each powder sample was tested under different amplitudes to determine the dependence of the packing density with the consolidation stress (σ_{c}). The applied acceleration can be estimated based on the formula, aω², where a is the amplitude of vibrations and ω corresponds to the frequency of vibrations. Furthermore, the applied acceleration may be normalized by gravitational acceleration. In an exemplary embodiment, the acceleration or vibration amplitude of the shaker 12 is maintained from about 0 g to about 10 g, where g is the gravitational acceleration. In one embodiment, the acceleration or vibration amplitude of the shaker 12 is maintained from about 0 g to about 5 g.

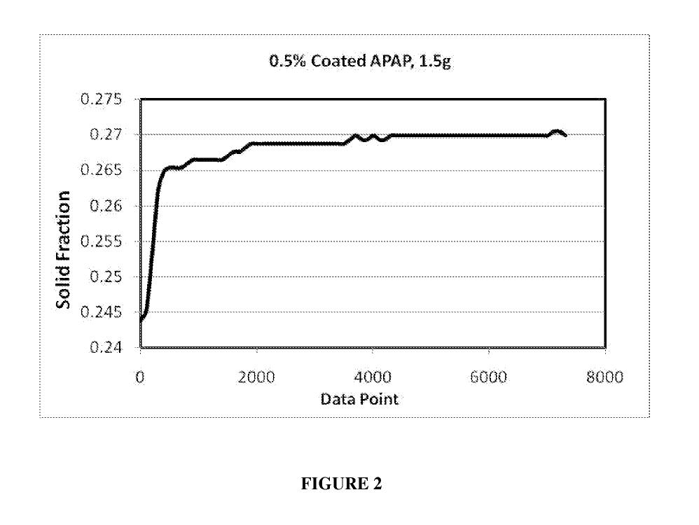

FIG. 2 depicts results of continuously sampled values of packing density of Acetaminophen (APAP) coated with silica shown as a function of time at a given applied acceleration. For example and as depicted in FIG. 2, the packing density of APAP coated with about 0.5% silica was continuously sampled at an applied acceleration of 1.5 g, and the values of packing density are shown as a function of time. In general, to obtain a series of such plots, the vibration at a given value of amplitude and frequency is applied for a time duration sufficient to achieve a plateau for the value of packing density in the curve of packing density versus time of applied vibration, as shown for example in FIG. 2. In exemplary embodiments, for each case of applied acceleration (e.g., from about 0 g to about 10 g), the time to reach a plateau ranges from about two to about fifteen minutes, and this may be selected by those skilled in the art. As shown in FIG. 2, the exemplary plateau is reached in about 7 minutes and that plateau value is taken as the final value of the packing density at that particular applied acceleration condition (e.g., 1.5 g).

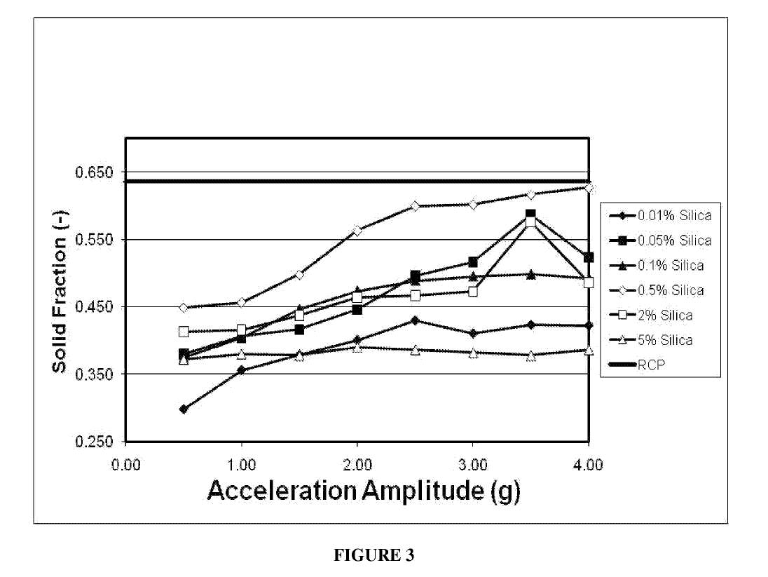

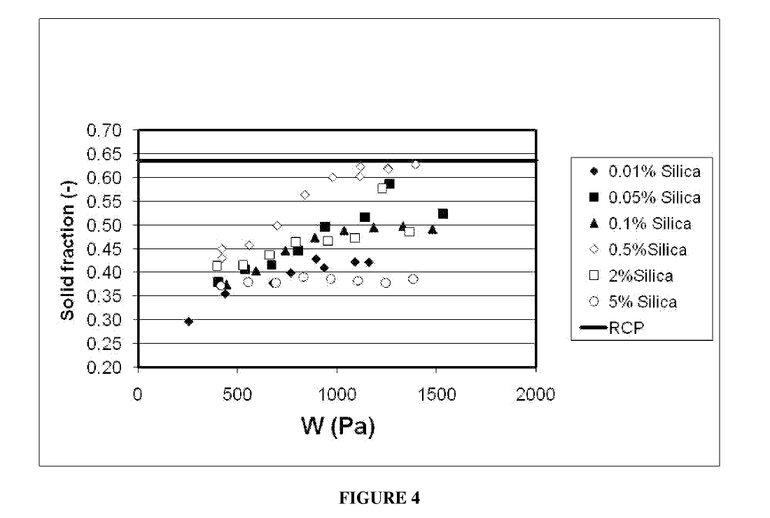

FIGS. 3-4 each depicts results of a packing density study using cornstarch coated with various levels of silica. In exemplary embodiments, powder starting materials were: cornstarch (diameter of about 15 μm, density 1.55 g/cm³) and silica R972 (diameter of about 16 nm, density=2.55 g/cm³, hydrophobic). The powders were processed in a Magnetic Assisted Impaction Coater (MAIC).

FIG. 3 depicts results of a packing density study using cornstarch coated with various levels of silica shown as a function of applied acceleration. As shown in FIG. 3, the solid fraction, a measure of packing density, increases as both the acceleration or vibration amplitude increases and as the coating level of silica is increased up to a point (e.g., beyond a certain level of added silica, packing density decreases). Each powder was packed utilizing vibration of acceleration. A trend was obtained for the solid fraction for each level of silica coating, indicating a continuous measurement of the packing density. For example, such a trend would be similar to the trend as illustrated in FIG. 2. As shown in FIG. 3, the plots indicate that for very high amounts of silica, the packing density decreases, indicating poor flow. Thus, through plots like FIG. 3, the influence of the amount of coating on the powder properties such as flow may be accurately characterized.

FIG. 4 depicts results of a packing density study using cornstarch coated with various levels of silica shown as a function of apparent weight of the powder bed. As depicted in FIG. 4, the solid fraction, a measure of packing density, increases as both the apparent weight increases and as the coating level of silica is increased up to a point (e.g., beyond a certain level of added silica, packing density decreases). The apparent weight is a calculated measurement taking the effects of the weight of the powder, the vibration acceleration, the frequency of vibration and the amplitude of the vibrations. A trend was obtained for the solid fraction for each level of silica coating, which indicates a continuous measurement of the packing density.

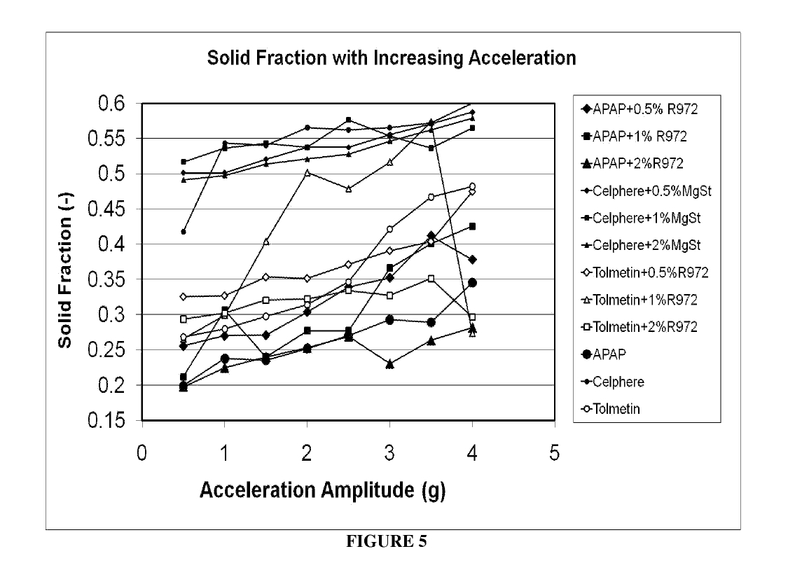

FIG. 5 depicts results of a packing density study using materials (both materials coated with various levels of additives, and uncoated materials) shown as a function of applied acceleration. As shown in FIG. 5, several materials were tested utilizing one exemplary embodiment of the present disclosure, as discussed above. Each material and/or powder was packed utilizing vibration of acceleration as in the exemplary embodiments above. Some of the materials and/or powders tested were two active pharmaceutical ingredients (“APIs”): (i) Acetaminophen (“APAP”); and (ii) Tolmetin Sodium (“Tolmetin”). A pharmaceutical excipient, Celphere (Asahi Kasei CP102, Japan) was tested as well. For example, the APIs were coated with nano-silica in an MAIC for the purpose of flow improvement, while the excipient (Celphere) was coated with Magnesium Stearate to prepare an improved excipient/additive for tabletting applications. The testing utilizing an exemplary embodiment was carried out to examine the influence of silica on flow properties of the APIs and to examine any adverse effect on flow due to addition of Magnesium Stearate on the excipient. As depicted in FIG. 5, the solid fraction, a measure of packing density, increases as both the acceleration or vibration amplitude increases. As shown in FIG. 5, for the APIs, coating by silica increases the packing fraction for coating up to about 1% by weight, but further increase in the amount of silica does not provide further improvement in packed density. Thus, FIG. 5 illustrates use of one exemplary embodiment of the present disclosure in characterizing powder property for modified powders. Similarly, the results for Celphere indicate that adding Magnesium Stearate does not adversely affect the packing density or flow property. The described approach is valid for a variety of dry APIs, excipients, and other materials or the like, with or without property modification by means of additives such as, without limitation, nano-silica, nano-titania, talc, magnesium stearate, etc.

The systems and methods of the present disclosure are also valid for a new class of ultra-fine energetic materials, including, but not limited to, fine powders of aluminum, magnesium, etc., with additives such as, for example, silica, carbon black, etc.

The packing density of each powder measured as a function of the consolidation stress is a meaningful indicator of the flowability of each powder. Typically, the powders that have in general higher packing density and a trend of increasing packing density as a function of applied consolidation stress will be the powders with the desired flow properties (e.g., ease of flowability, fluidization behavior, etc.). Thus, the overall flow behavior will be evaluated based on a set of dynamic measurements, resulting in a full curve rather than a single value. On the other hand, a single value of packing density (also called tapped density) can not give as much information as a complete trend that the present disclosure provides. In exemplary embodiments of the present disclosure, system 10 provides improved characterization or specification of powder or packing density as a function of consolidation stress. The systems and methods of the present disclosure provide characterization or measurement results in a series of curves (e.g., FIGS. 3-5) for the packing density, as opposed to a single value generated in most conventional methods.

Furthermore, the packing density results obtained from the systems and methods of the present disclosure may also be utilized to compute the Hausner ratio in order to measure or characterize the flow properties of the powders. The Hausner ratio is used in some industries (e.g., pharmaceutical industry) as an indication of the flowability of a powder. In general, the Hausner ratio is the ratio of the tapped or packed bulk density to the aerated bulk density. With the systems and methods of the present disclosure, due to the initialization step that involves fluidizing the powder sample, this results in erasing the “memory” effect due to prior state of the powder and thus provides a more accurate result for the aerated bulk density. Consequently, the systems and methods of the present disclosure provide for improved characterization or definition of a parameter like the Hausner ratio. The significance of the Hausner ratio may be improved by knowledge of the consolidation stress acting on the powder. For example, by comparing the packing density relative to the consolidation stress acting on the powder during the vibrations, this type of system/method for measuring/characterizing powders provides similar information to uniaxial compression tests, for example.

One advantage to at least one embodiment of the present disclosure is that the present disclosure provides for improved and cost effective systems/methods that provide accurate measurement and/or characterization results (e.g., packing density, flowability, and/or fluidization behavior) for ultra-fine or cohesive powders. Another advantage to at least one embodiment of the present disclosure is that the present disclosure also provides for improved systems/methods for measuring and/or characterizing properties of ultra-fine or cohesive powders, wherein the accurate knowledge of certain properties of the powders (e.g., packing density, flowability, etc.) may be beneficial in industrial applications (e.g., powder filling processes, pharmaceutical applications, etc.), thereby providing a significant manufacturing and commercial advantage as a result. Another advantage to at least one embodiment of the present disclosure is that the present disclosure also provides for systems and methods for measuring and/or characterizing properties of ultra-fine or cohesive powders, wherein differences in the flowability and/or fluidization behavior between different ultra-fine or cohesive powders may be detected, and wherein the accurate knowledge of the differences in the flowability and/or fluidization behavior between the powders may be beneficial in industrial applications, thereby providing a significant manufacturing and commercial advantage as a result.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A powder measuring device system comprising:
a shaker that includes a plate, the plate configured and dimensioned to releasably secure a cell containing a given mass of ultra-fine powder;
a container of material having a flow line in communication with a flow controller, the flow controller having an output line in communication with the cell;
a controller in communication with the shaker, the controller configured to operate and maintain the shaker at a vibration amplitude or tapping setting;
wherein the flow controller is configured to control a flow rate of the material from the container to the cell;
wherein the material is supplied to the cell at a flow rate to fluidize the powder in the cell until the powder is fully expanded;
wherein the height of the powder in the cell is measured and monitored while the material is supplied to the cell;
wherein the supply of material is shut off after the powder is fully expanded and the powder is allowed to collapse undisturbed;
wherein the height of the collapsed undisturbed powder in the cell is measured; and
wherein after the height of the collapsed undisturbed powder is measured, vibrations or taps are applied to the cell by the shaker, and the height of the powder in the cell is measured and recorded as a function of time.

2. The measuring device system of claim 1 further comprising a sensor in communication with the cell, the sensor configured to measure, record and monitor the height of the powder in the cell, and
wherein the height of the powder in the cell is measured, recorded and monitored by the sensor.

3. The measuring device system of claim 1, wherein the shaker is an electrodynamic shaker.

4. The measuring device system of claim 1, wherein the shaker is configured and dimensioned to subject the cell to vertical taps.

5. The measuring device system of claim 1, wherein the cell is a cylindrical fluidization cell.

6. The measuring device system of claim 1, wherein the plate is a sintered porous stainless steel distributor plate.

7. The measuring device system of claim 1, wherein the ultra-fine powder is less than about 25 microns in particle size.

8. The measuring device system of claim 1, wherein the container is a gas container that contains a supply of gas.

9. The measuring device system of claim 1, wherein the container is a dry nitrogen container that contains a supply of dry nitrogen (dry N₂).

10. The measuring device system of claim 1, wherein the flow controller is a rotameter.

11. The measuring device system of claim 2, wherein the sensor is an ultrasound sensor; and
wherein said sensor is positioned on top of the cell.

12. The measuring device system of claim 2, wherein the sensor is connected to a processor.

13. The measuring device system of claim 1, further comprising an accelerometer in communication with the cell, the accelerometer configured to measure the vertical acceleration of the cell; and
a power amplifier in communication with the accelerometer and the shaker, wherein the controller and the power amplifier are configured to operate and maintain the shaker at a vibration amplitude or tapping setting.

14. The measuring device system of claim 13, wherein the accelerometer is a piezoelectric accelerometer.

15. The measuring device system of claim 13, wherein the accelerometer is positioned on the upper part of the cell.

16. The measuring device system of claim 1, wherein the controller is a vibration or tapping controller.

17. The measuring device system of claim 13, wherein the vibration amplitude or tapping setting is maintained by operating the shaker in a closed loop configuration using the controller and the power amplifier.

18. The measuring device system of claim 1, wherein the material supplied to the cell from the container is gas.

19. The measuring device system of claim 1, wherein the material supplied to the cell from the container is dry nitrogen (dry N₂).

20. The measuring device system of claim 1, wherein the flow rate of material supplied to the cell is increased while the height of the powder in the cell is measured and monitored.

21. The measuring device system of claim 1, wherein the flow rate of material is maintained at a constant or variable rate for about 30 seconds after the powder is fully expanded.

22. The measuring device system of claim 1, wherein the powder in the cell is shaken or tapped at least once by the shaker when the material is supplied to the cell.

23. The measuring device system of claim 1, wherein the frequency of the vibrations applied to the cell is fixed at about 60 Hz.

24. The measuring device system of claim 1, wherein the frequency of the vibrations applied to the cell is from about 1 Hz to about 1000 Hz.

25. The measuring device system of claim 2, wherein the height of the powder in the cell is measured and recorded by the sensor while or after the vibrations or taps are applied to the cell, and wherein the height of the powder in the cell is measured and recorded by the sensor at a rate of about 20 Hz.

26. The measuring device system of claim 1, wherein the vibration amplitude setting is from about 0 to about 2.5 mm.

27. The measuring device system of claim 1, wherein the vibration amplitude is from about 0 g to about 10 g.

28. The measuring device system of claim 1, wherein the tapping setting is set at a frequency of a tap in a range from about every five seconds to a tap about everyone second.

29. The measuring device system of claim 28, wherein there is a finite time of relaxation between each consecutive tap.

30. A method for measuring a powder, the method comprising:
providing a shaker that includes a plate, the plate configured and dimensioned to releasably secure a cell containing a given mass of ultra-fine powder;
providing a container of material having a flow line in communication with a flow controller, the flow controller having an output line in communication with the cell, and wherein the flow controller is configured to control a flow rate of the material from the container to the cell;
providing a controller in communication with the shaker, the controller configured to operate and maintain the shaker at a vibration amplitude or tapping setting; supplying the material to the cell at a flow rate to fluidize the powder in the cell until the powder is fully expanded;
measuring and monitoring the height of the powder in the cell while the material is supplied to the cell;
shutting off the supply of material after the powder is fully expanded;
allowing the powder to collapse undisturbed;
measuring the height of the collapsed undisturbed powder in the cell;
applying vibrations or taps to the cell with the shaker after the height of the collapsed undisturbed powder is measured; and
measuring and recording the height of the powder in the cell as a function of time while or after the vibrations or taps are applied to the cell.

31. The method of claim 30, further comprising a sensor in communication with the cell, the sensor configured to measure, record and monitor the height of the powder in the cell; and
measuring, recording and monitoring the height of the powder in the cell with the sensor.

32. The method of claim 30, wherein the shaker is an electrodynamic shaker.

33. The method of claim 30, wherein the shaker is configured and dimensioned to subject the cell to vertical taps.

34. The method of claim 30, wherein the cell is a cylindrical fluidization cell.

35. The method of claim 30, wherein the plate is a distributor plate.

36. The method of claim 35, wherein the plate is a sintered porous stainless steel distributor plate.

37. The method of claim 30, wherein the ultra-fine powder is less than about 25 microns in particle size.

38. The method of claim 30, wherein the container is a gas container that contains a supply of gas.

39. The method of claim 30, wherein the container is a dry nitrogen container that contains a supply of dry nitrogen (dry N₂).

40. The method of claim 30, wherein the flow controller is a rotameter.

41. The method of claim 31, wherein the sensor is an ultrasound sensor.

42. The method of claim 31, wherein the sensor is positioned on top of the cell.

43. The method of claim 31, wherein the sensor is connected to a processor.

44. The method of claim 30, further comprising providing an accelerometer in communication with the cell, the accelerometer configured to measure the vertical acceleration of the cell; and
providing a power amplifier in communication with the accelerometer and the shaker, wherein the controller and the power amplifier are configured to operate and maintain the shaker at a vibration amplitude or tapping setting.

45. The method of claim 44, wherein the accelerometer is a piezoelectric accelerometer.

46. The method of claim 44, wherein the accelerometer is positioned on the upper part of the cell.

47. The method of claim 30, wherein the controller is a vibration or tapping controller.

48. The method of claim 44, wherein the vibration amplitude or tapping setting is maintained by operating the shaker in a closed loop configuration using the controller and the power amplifier.

49. The method of claim 30, wherein the material supplied to the cell from the container is gas.

50. The method of claim 30, wherein the material supplied to the cell from the container is dry nitrogen (dry N₂).

51. The method of claim 30, wherein the flow rate of material supplied to the cell is increased while the height of the powder in the cell is measured and monitored.

52. The method of claim 30, wherein the flow rate of material is maintained at a constant or variable rate for about 30 seconds after the powder is fully expanded.

53. The method of claim 30, wherein the powder in the cell is shaken or tapped at least once by the shaker when the material is supplied to the cell.

54. The method of claim 30, wherein the frequency of the vibrations applied to the cell is fixed at about 60 Hz.

55. The method of claim 30, wherein the frequency of the vibrations applied to the cell is from about 1 Hz to about 1000 Hz.

56. The method of claim 31, wherein the height of the powder in the cell is measured and recorded with the sensor while or after the vibrations or taps are applied to the cell, and wherein the height of the powder in the cell is measured and recorded with the sensor at a rate of about 20 Hz.

57. The method of claim 30, wherein the vibration amplitude is from about 0 g to about 10 g.

58. The method of claim 30, wherein the tapping setting is set at a frequency of a tap in a range from about every five seconds to a tap about every one second.

59. The method of claim 58, wherein there is a finite time of relaxation between each consecutive tap.
